(19) United States
(12) Patent Application Publication
(10) Pub. No.: US 2025/0094759 A1
(43) Pub. Date: Mar. 20, 2025

(54) BIOMETRIC ELECTRONIC CARD AND CASE

(71) Applicant: Michael Blackstone, Halethorpe, MD (US)

(72) Inventor: Michael Blackstone, Halethorpe, MD (US)

(21) Appl. No.: 18/435,593

(22) Filed: Feb. 7, 2024

Related U.S. Application Data
(60) Provisional application No. 63/629,088, filed on Sep. 18, 2023.
(60) Provisional application No. 63/576,388, filed on Feb. 7, 2023.

(51) Int. Cl. G06K 19/073

(52) U.S. Cl. CPC G06K 19/07354

(57) ABSTRACT

A biometric electronic card is disclosed. The biometric electronic card includes an electronic transactions unit to enable secure financial transactions; a communications network unit; a card data encoding storage; an input/output unit to interact with the biometric electronic card and to verify biometrics of a user; a power source; and a location positioning unit, where the electronic transactions unit, the communications network unit, the card data encoding storage, the input/output unit, the power source and the location positioning unit are all integrated with the biometric electronic card. A biometric electronic card case for interaction with the biometric electronic card is disclosed. The biometric electronic card case includes an input/output unit; a securing mechanism; a protective cover surrounding the biometric electronic card case; an integrated biometric electronic card case circuit; a power source; a communications unit; a processing unit; and a location positioning unit.

### RELATED APPLICATIONS

This application claims benefit to provisional application U.S. 63/576,388 filed on Feb. 7, 2023 and provisional application U.S. 63/629,088 filed on Sep. 18, 2023.

### BACKGROUND

### Technical Field

This disclosure relates to secure electronic cards. In particular, the disclosure relates to, and without limitation, to a bioelectric electronic card and a case for the same.

Secure electronic cards are known in the art.

U.S. Pat. No. 8,991,696 describes an electronic corporate credit system and biometric identification and documentation card.

U.S. Pat. No. 10,453,053 describes systems and devices for wireless charging of a powered transaction card and embedding electronics in a wearable accessory.

U.S. Pat. No. 9,466,060 describes a system and method for validating identity for international use of an electronic payment card.

WO 2020/14671 describes an electronic transaction card.

US 2005/0187883 describes methods and apparatus for conducting electronic transactions using biometrics.

While secure electronic cards are known in the art, there is a lack of a biometric electronic card with integrated components that may be necessary to use the biometric card reliably in communication with services that require identification using the card. Also, there is a lack of biometric electronic cards that work with complementary electronic cases for convenient and safe usage of the biometric electronic card and keep it protected from the elements and electronic snooping or swiping.

Therefore, a need exists for a biometric electronic card and case as disclosed in the present application.

### COPYRIGHT NOTICE

A portion of the disclosure of this patent document contains material, which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### SUMMARY

A biometric electronic card is disclosed. The biometric electronic card includes an electronic transactions unit to enable secure financial transactions; a communications network unit; a card data encoding storage; an input/output unit to interact with the biometric electronic card and to verify biometrics of a user; a power source; and a location positioning unit, where the electronic transactions unit, the communications network unit, the card data encoding storage, the input/output unit, the power source and the location positioning unit are all integrated with the biometric electronic card.

A biometric electronic card case for interaction with the biometric electronic card is disclosed. The biometric electronic card case includes an input/output unit; a securing mechanism; a protective cover surrounding the biometric electronic card case; an integrated biometric electronic card case circuit; a power source; a communications unit; a processing unit; and a location positioning unit.

Other systems, methods, features and advantages of the disclosure will be, or will become, apparent to one with skill in the art upon examination of the following figures and detailed description. It is intended that all such additional systems, methods, features and advantages be included within this description, be within the scope of the disclosure, and be protected by the following claims.

### BRIEF DESCRIPTION OF THE DRAWINGS

The disclosure can be better understood with reference to the following drawings and description. The components in the figures are not necessarily to scale, emphasis instead being placed upon illustrating the principles of the disclosure. Moreover, in the figures, like referenced numerals designate corresponding parts throughout the different views.

FIG. 1 is a view of a biometric electronic card, according to the disclosure.

FIG. 2 is another view of a biometric electronic card, according to the disclosure.

FIG. 3 is another view of a biometric electronic card, according to the disclosure.

FIG. 4 is a view of a biometric electronic card case, according to the disclosure.

FIG. 5 is another view of a biometric electronic card and a biometric electronic card case, according to the disclosure.

FIG. 6 is another view of a biometric electronic card and a biometric electronic card case, according to the disclosure.

### DETAILED DESCRIPTION

A biometric electronic card is disclosed. The biometric electronic card includes an electronic transactions unit to enable secure financial transactions; a communications network unit; a card data encoding storage; an input/output unit to interact with the biometric electronic card and to verify biometrics of a user; a power source; and a location positioning unit, where the electronic transactions unit, the communications network unit, the card data encoding storage, the input/output unit, the power source and the location positioning unit are all integrated with the biometric electronic card.

A biometric electronic card case for interaction with the biometric electronic card is disclosed. The bioelectronic card case includes an input/output unit; a securing mechanism; a protective cover surrounding the biometric electronic card case; an integrated biometric electronic card case circuit; a power source; a communications unit; a processing unit; and a location positioning unit.

Various aspects of the present disclosure will be described in detail with reference to the drawings, wherein like reference numerals represent like parts and assemblies throughout the several views. Reference to various aspects does not limit the scope of the disclosure, which is limited only by the scope of the claims attached hereto. Additionally, any examples set forth in this specification are not intended to be limiting and merely set forth some of the many possible aspects for the claimed disclosure.

In describing aspects of the present disclosure, the following terminology will be used. The singular forms “a,” “an,” and “the” include plural referents unless the context clearly dictates otherwise. As used herein, a plurality of items, structural elements, compositional elements, and/or materials may be presented in a common list for convenience. However, these lists should be construed as though each member of the list is individually identified as a separate and unique member. Thus, no individual member of such list should be construed as a de facto equivalent of any other member of the same list solely based on their presentation in a common group without indications to the contrary. As used herein, the singular forms “a,” “an,” and “the” are intended to include the plural forms as well, unless the context clearly indicates otherwise.

It further will be understood that the terms “comprises,” “comprising,” “includes,” and “including” specify the presence of stated features, steps or components, but do not preclude the presence or addition of one or more other features, steps or components. It also should be noted that in some alternative implementations, the functions and acts noted may occur out of the order noted in the figures. For example, two figures shown in succession may in fact be executed substantially concurrently or may sometimes be executed in the reverse order, depending upon the functionality and acts involved.

As used herein, the term “about” means that dimensions, sizes, formulations, parameters, shapes, and other quantities and characteristics are not and need not be exact but may be approximated and/or larger or smaller, as desired, reflecting tolerances, conversion factors, rounding off, measurement error and the like, and other factors known to those of skill. Further, unless otherwise stated, the term “about” shall expressly include “exactly.”

The terms “communicate,” or “communication” refer to any component(s) connecting with any other component(s) in any combination, whether through direct physical connection, intermediary physical connection or wirelessly connected for the purpose of the connected components to communicate, interact, transfer energy or motion and/or transfer data to and from any components and/or control any settings.

In the following description, numerous specific details are set forth to clearly describe various specific aspects disclosed herein. One skilled in the art, however, will understand that the presently claimed disclosure may be practiced without all of the specific details discussed below. In other instances, well-known features have not been described so as not to obscure the disclosure. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings. In addition, the terms “connected” and “coupled” and variations thereof are not restricted to physical or mechanical connections or couplings. In addition, it should be understood that aspects of the disclosure include both hardware and electronic components or modules that, for purposes of discussion, may be illustrated and described as if the majority of the components were implemented solely in hardware. However, one of ordinary skill in the art, and based on a reading of this detailed description, would recognize that, in at least one aspect, the electronic based aspects of the disclosure may be implemented in software. As such, it should be noted that a plurality of hardware and software-based devices, as well as a plurality of different structural components may be utilized to implement the disclosure. Furthermore, and as described in subsequent paragraphs, the specific mechanical configurations illustrated in the drawings are intended to exemplify aspects of the disclosure and that other alternative mechanical configurations are possible.

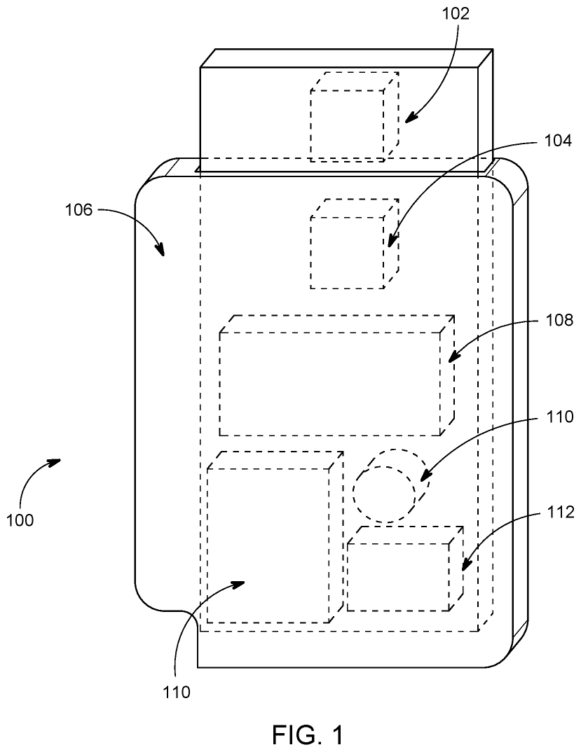

A biometric electronic card (“BEC”) is disclosed. FIG. 1 illustrates a front view of an example BEC 100, according to an aspect of the disclosure. The BEC 100 may include multiple components. In an aspect, the BEC 100 may include an electronic transactions unit 102. Examples of the electronic transactions unit 102 may include an E.M.V. (Europay, Mastercard, Visa) or other electronic transactions card chip known to one of skill in the art.

In an aspect, the electronic transactions unit 102 of the BEC 100 may be capable of conducting any transactions that can be made by transferring money by way of bank wire transfer, CashApp, Zelle, Venmo, Western Union, China UnionPay, Weixin Pay, PayPal and the like.

As defined in the present application, for illustrative purposes but without limitation, EMV is a payment method based on a technical standard for smart payment cards and for payment terminals and automated teller machines which can accept them. EMV stands for “Europay, Mastercard, and Visa”, the three companies that created the standard. EMV cards are smart cards, also called chip cards, integrated circuit cards, or IC cards, which store their data on integrated circuit chips, in addition to magnetic stripes for backward compatibility. These include cards that must be physically inserted or “dipped” into a reader, as well as contactless cards that can be read over a short distance using near-field communication technology. Payment cards which comply with the EMV standard are often called chip and PIN or chip and signature cards, depending on the authentication methods employed by the card issuer, such as a personal identification number (PIN) or electronic signature. Standards exist, based on ISO/IEC 7816, for contact cards, and based on ISO/IEC 14443 for contactless cards.

In an aspect, the BEC 100 may include a communications network unit 104. In an aspect, the communications network unit 104 may include a SIM card or Subscriber Identity Module

As defined in the present application, for illustrative purposes but without limitation, a SIM card (Subscriber Identity Module or Subscriber Identification Module) is an integrated circuit (IC) intended to securely store an international mobile subscriber identity (IMSI) number and its related key, which are used to identify and authenticate subscribers on mobile telephone devices (such as mobile phones and laptops). Technically the actual physical card is known as a universal integrated circuit card (UICC); this smart card is usually made of PVC with embedded contacts and semiconductors, with the SIM as its primary component. In practice the term “SIM card” refers to the entire unit and not simply the IC. A SIM contains a unique serial number, integrated circuit card identification (ICCID), international mobile subscriber identity (IMSI) number, security authentication and ciphering information, temporary information related to the local network, a list of the services the user has access to, and four passwords: a personal identification number (PIN) for ordinary use, and a personal unblocking key (PUK) for PIN unlocking as well as a second pair (called PIN2 and PUK2 respectively) which are used for managing fixed dialing number and some other functionality.

In an aspect, the BEC 100 may include a card data encoding storage 106. In an aspect, the card data encoding storage 106 may include a magnetic strip to encode and store card data.

In an aspect, the BEC 100 may include an input/output (I/O) unit 108, such as a display screen or tactile interface. In an aspect, the I/O unit 108 may include a touchscreen, OLED display, TTY interface, button interface, joystick, track ball or other I/O interface known to one of skill in the art. In an aspect, the BEC 100 may include a communication unit 110. In an aspect, the communications unit 110 may include a speaker or an audio jack or output for communicating information audibly.

In an aspect, the BEC 100 may include a power source 112. In an aspect, the power source 112 may include a rechargeable battery, such as a lithium ion or other rechargeable battery. In an aspect, the power source 112 may be a conventional alkaline battery, renewable power source such as a solar panel, a thermoelectric unit, hand-cranked or motion activated power source or an input to an external power source.

In an aspect, the BEC 100 may include a location positioning unit 114. In an aspect, the location positioning unit 114 may include a GPS unit, GNSS unit, cellular positioning unit, Wi-Fi or Bluetooth positioning unit or other location positioning technologies known to one of skill in the art.

In an aspect, the BEC 100 may be composed of plastic or another type of resilient. In an aspect, the BEC 100 may be rectangular-shaped, square-shaped or other shape that is convenient for transportation and storage by a user. In an aspect, the electronic transactions unit 102 may be rectangular- or square-shaped and may be composed of a silicon chip, flexible electronics or other small-profile chip technology. In an aspect, the communications network unit 104 may be composed of plastic and may be rectangular- or square-shaped and resilient. In an aspect, the card data encoding storage 106 may be plastic or other durable material, of sufficient length for the BEC 100 and resilient.

In an aspect, the I/O unit 108 may be plastic or glass or thin film material, rectangular- or square-shaped and resilient. In an aspect, the communication unit 110 may be plastic or other durable material, round-shaped or other shape convenient to integrate with the BEC 100 and resilient. In an aspect, the location positioning unit 114 may be an integrated circuit unit, may be plastic, round and resilient.1

In an aspect, the BEC 100, the electronic transactions unit 102, the communications network unit 104, the card data encoding storage 106, the I/O unit 108, the communications unit 110, the power source 112 and the location positioning unit 114 are all integral.

In an aspect of the disclosure, the BEC 100 may be considered more generally, but not limited, as follows: 1. a Biometric Electronic Card 100 that is a means for housing several components and is rectangular and plastic or another type of material; 2. a Europay/Mastercard/Visa chip 102 that is a means for making transactions with card readers that is incorporated into the Biometric Electronic Card 100 and that is silicon-based and rectangular; 3. a SIM card 104 that is a Subscribe Identity Module and that is a means for connecting to networks, that is P.V.C/A.B.C and square-shaped and incorporated into the Biometric Electronic Card 100; 4. magnetic strips 106 that are a means for data storage and presentation when swiping with card readers and the like, are positioned along the length of the BEC 100 and resilient and that protrudes from the sides, top or bottom on the Biometric Electronic Card 100; 5. a screen 108 that is biometric and a means for interaction of finger print, facial, iris, blood vessel patterns and any other type of biometrics, that is rectangular- or square-shaped and plastic and that is built into the Biometric Electronic Card 100; 6. a speaker 110 that is a means for voice interaction and is round and plastic and built into the body of the Biometric Electronic Card 100; 7. a rechargeable battery 112 that is a means for power that is rectangle and uses lithium ion or other rechargeable battery material; and 8. a GPS unit 114 that is a means of locating the Biometric Electronic Card 100.

The Biometric Electronic Card has many applications. It can be used as any kind of banking, value storage or debit card. Biometric Electronic Card may also be used as any type of ID Card, such as a driver's license, visa, passport, social security card, access card for buildings or locations, where these application-specific purposes can be incorporated into the Biometric Electronic Card though an electronic download onto the Biometric Electronic Card that is incorporated with EMV, SIM or another type of chip that will allow different kinds of downloads. This will secure the safety of these applications by biometrics. In an aspect, the electronic transactions unit 102 of the BEC 100 may be capable of conducting any transactions that can be made by transferring money by way of bank wire transfer, CashApp, Zelle, Venmo, Western Union, China UnionPay, Weixin Pay, PayPal and the like. This list is exemplary and not limited to the foregoing and has more capabilities. The Biometric Electronic Card is very thin and compact and interacts with all card- and chip-readers.

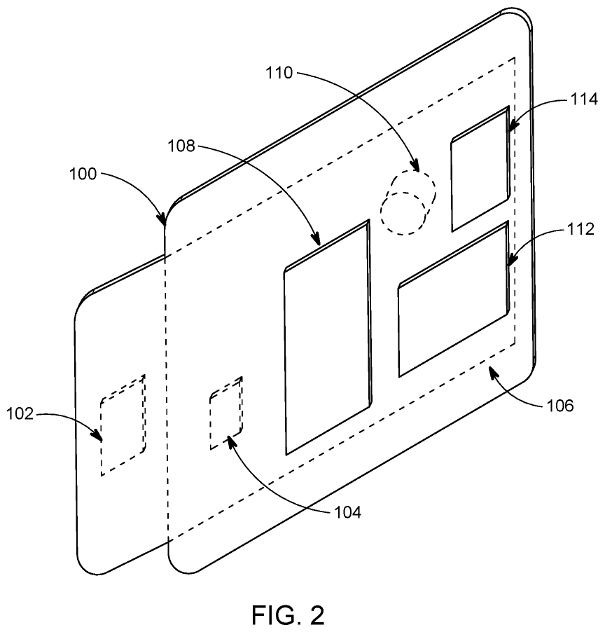

FIG. 2 is an exemplary side view of the BEC 100. In an aspect, the electronic transactions unit 102, the communications network unit 104, the card data encoding storage 106, the I/O unit 108, the communications unit 110, power source 112 and location positioning unit 114 may all function and have properties as disclosed above with reference to FIG. 1.

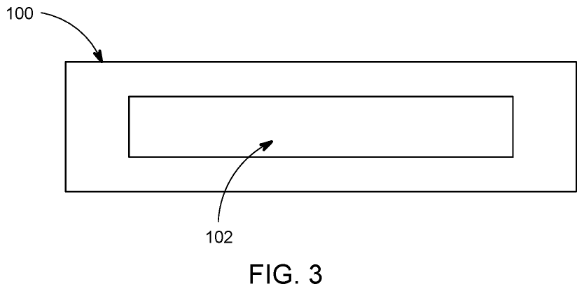

FIG. 3 is an exemplary top view of the BEC 100. In an aspect, the electronic transactions unit 102 may function and have properties as disclosed above with reference to FIG. 1, only displayed in a top view of the BEC 100 as an integrated unit.

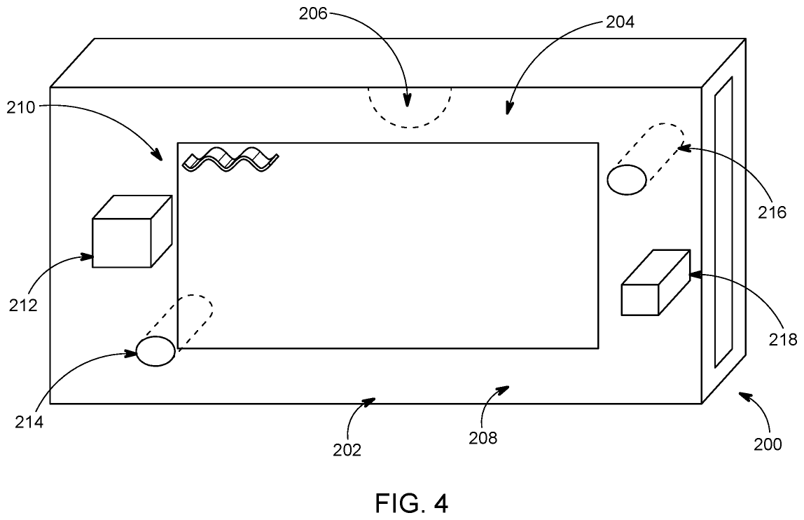

A biometric electronic card case (“BECC”) is disclosed and that can be utilized separately or in tandem with a BEC 100 as described above with references to FIGS. 1-3. FIG. 4 illustrates an example BECC 200. In an aspect, the BECC 200 may be a means for housing or storing the BEC 100. The BECC 200 is a means for housing and interaction with the BEC 100 and other components of the biometric electronic card case 200. The BECC 200, in an aspect, may be rectangular and plastic or some other type of material and is a means for housing and interaction with the BEC 100. In an aspect, the BECC 200 may include a case 202 for storing a BEC 100 internally, either partially or wholly enclosing the BEC 100. In an aspect, the BECC 200 may include an I/O unit 204, such as a display screen or tactile interface. In an aspect, the I/O unit 108 may include a touchscreen, OLED display, TTY interface, button interface, joystick, track ball or other I/O interface known to one of skill in the art. In an aspect, the I/O unit 204 may be a screen that is glass and is rectangular, resilient and is a means for interacting with the BEC 100 and BECC 200.

In an aspect, the BECC 200 may include a securing mechanism 206, such as a lock. In an aspect, the lock may be operated with a key, a magnetic locking mechanism, combination lock or other conventional locking means known to one of skill in the art. In an aspect, the BECC 200 may include a protective cover 208 to protect the BECC 200 from the elements or liquids that may damage the BECC 200.

In an aspect, the BECC 200 may include an integrated biometric electronic card case circuit 210 that is a means of interaction with the BECC 200 and the BEC 100. In an aspect, the BECC 200 may include a power source 212. In an aspect, the power source 212 may include a rechargeable battery, such as a lithium ion or other rechargeable battery. In an aspect, the power source 212 may be a conventional alkaline battery, a renewable power source such as a solar panel, a thermoelectric unit, hand-cranked or motion activated power source or an input to an external power source.

In an aspect, the BECC 200 may include a communication unit 214. In an aspect, the communications unit 214 may include a speaker or an audio jack or output for communicating information audibly.

In an aspect, the BECC 200 may include a processing unit 216, such a CPU or other processor that is a means for processing information for the BECC 200 and that can be integrated with the BEC 100. Examples of the processing unit 216 may be an Application-Specific Integrated Circuit (ASIC) processor, a Complex Instruction Set Computing (CISC) processor, a central processing unit (CPU), an Explicitly Parallel Instruction Computing (EPIC) processor, a Very Long Instruction Word (VLIW) processor, and/or other processors or circuits.

In an aspect, the BECC 200 may include a location positioning unit 218. In an aspect, the location positioning unit 218 may include a GPS unit, GNSS unit, cellular positioning unit, Wi-Fi or Bluetooth positioning unit or other location positioning technologies known to one of skill in the art. In an aspect, the location positioning unit 218 may serve as a means for locating the BECC 200 and the BEC 100.

In an aspect, the BECC 200 may be plastic, rectangular and resilient. The I/O unit 204, such as a case screen may be a glass or thin film material, rectangular and resilient. The securing mechanism 206, such as a biometric electronic card case lock, may be magnetic, round and resilient. In an aspect, the protective cover 208 may be plastic, rectangular and resilient.

In an aspect, the processing unit 214 may be a silicon integrated circuit, flat and resilient. In an aspect, the power source 212 may be a lithium ion or other rechargeable battery material, rectangular- or square-shaped and resilient. The communication unit 214 may be plastic, round and resilient.

In an aspect, processing unit 214 may silicon integrated circuit, flat and resilient. In an aspect, the location positioning unit 216 may be plastic, round and resilient.

In an aspect, the BECC 200, the I/O unit 204, securing mechanism 206 and the protective cover 208 may all be integral.

In an aspect, the integrated biometric electronic card case circuit 210, the power source 212, communication unit 214, processing unit 214 and the location positioning unit 216 are integral.

The disclosed BECC 200 may have many applications that can be used in sync and in tandem with the BEC 100. In an aspect, the BECC 200 can share and utilize electronic information from the BEC 100 and can secure a credit card, debit or crypto currency information and interaction. The BECC 200 may also secure any type of ID card such as driver's license.

In an aspect, the BECC 200 can serve as, for example but not limited to, a social security card, passport, visa and the like. The BECC 200 can be detached from the BEC 100 to give to law enforcement, bankers, or any entity that needs verification and the like. The BECC 200 also can facilitate any electronic interaction in a very secure fashion using biometrics between the BEC 100 and the BECC 200.

In an aspect, the BECC 200 may be capable of conducting any transactions that can be made by transferring money by way of bank wire transfer, CashApp, Zelle, Venmo, Western Union, China UnionPay, Weixin Pay, PayPal and the like, whether the BECC 200 acting alone or through interaction with the BEC 100.

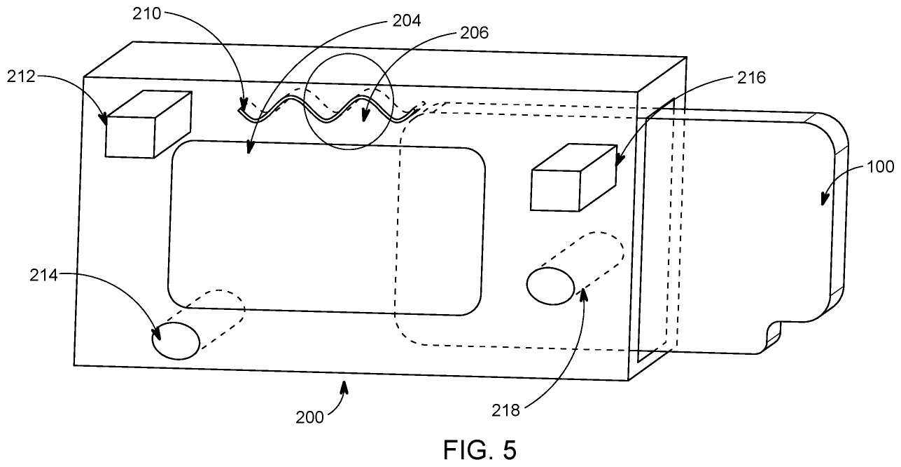

FIG. 5 illustrates an exemplary view of the BECC 200 and the BEC 100, with the BEC 100 extending out of the BECC 200. The components illustrated in FIG. 5 conform with the components with like reference numbers in FIGS. 1-4.

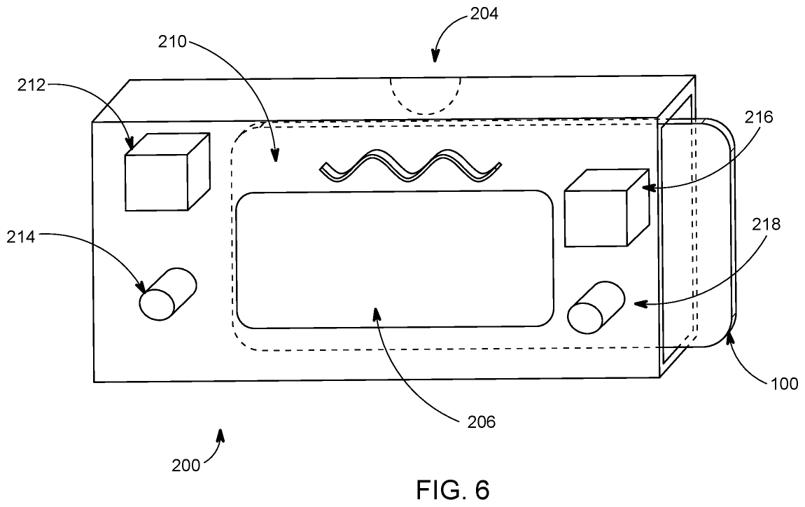

FIG. 6 illustrates an exemplary view of a BEC 100 inserted into a BECC 200.

FIG. 6 also shows a protective cover 208 of the BECC 200. The components illustrated in FIG. 5 conform with the components with like reference numbers in FIGS. 1-5.

While various aspects of the disclosure have been described, it will be apparent to those of ordinary skill in the art that many more aspects and implementations are possible within the scope of the disclosure. Accordingly, the disclosure is not to be restricted except in light of the attached claims and their equivalents.

What is claimed is:

1. A biometric electronic card comprising:
an electronic transactions unit to enable secure financial transactions;
a communications network unit;
a card data encoding storage;
an input/output unit to interact with the biometric electronic card and to verify biometrics of a user;
a power source; and
a location positioning unit, where the electronic transactions unit, the communications network unit, the card data encoding storage, the input/output unit, the power source and the location positioning unit are all integrated with the biometric electronic card.

2. The biometric electronic card of claim 1, where the electronic transactions unit comprises an EMV chip.

3. The biometric electronic card of claim 1, where the communications network unit comprises a subscriber identity module.

4. The biometric electronic card of claim 1, where the card data encoding storage comprises a magnetic strip.

5. The biometric electronic card of claim 1, where the input/output unit comprises at least one of the following: a touchscreen, an OLED display, a TTY interface, a button interface, a joystick, a track ball or a combination thereof.

6. The biometric electronic card of claim 1, where the power source comprises at least one of the following: a conventional alkaline battery, a rechargeable battery, a solar panel, a thermoelectric unit, hand-cranked power source, a motion activated power source, an input to an external power source or a combination thereof.

7. The biometric electronic card of claim 1, where the location positioning unit comprises at least one of the following: a GPS unit, a GNSS unit, a cellular positioning unit, a Wi-Fi positioning unit, a Bluetooth positioning unit or a combination thereof.

8. A biometric electronic card case comprising:
an input/output unit to interact with the biometric electronic card case and a biometric electronic card;
a securing mechanism configured to lock and unlock the biometric electronic card case;
a protective cover surrounding the biometric electronic card case;
an integrated biometric electronic card case circuit for electronic communication between the biometric electronic card case and a biometric electronic card;
a power source;
a communications unit;
a processing unit; and
a location positioning unit,
where the input/output unit, the securing mechanism and the protective cover are all integrated with the biometric electronic card case, and the integrated biometric electronic card case circuit, the power source, the communication unit and the location positioning unit are integrated together.

9. The biometric electronic card case of claim 8, where the input/output unit comprises at least one of the following: a touchscreen, an OLED display, a TTY interface, a button interface, a joystick, a track ball or a combination thereof.

10. The biometric electronic card case of claim 8, where the securing mechanism comprises a magnetic lock.

11. The biometric electronic card case of claim 8, where the processing unit comprises at least one of the following: an Application-Specific Integrated Circuit (ASIC) processor, a Complex Instruction Set Computing (CISC) processor, a central processing unit (CPU), an Explicitly Parallel Instruction Computing (EPIC) processor, a Very Long Instruction Word (VLIW) processor or a combination thereof.

12. The biometric electronic card case of claim 9, where the power source comprises at least one of the following: a conventional alkaline battery, a rechargeable battery, a solar panel, a thermoelectric unit, hand-cranked power source, a motion activated power source, an input to an external power source or a combination thereof.

13. The biometric electronic card case of claim 9, where the communications unit comprises a subscriber identity module.

14. The biometric electronic card case of claim 8, where the location positioning unit comprises at least one of the following: a GPS unit, a GNSS unit, a cellular positioning unit, a Wi-Fi positioning unit, a Bluetooth positioning unit or a combination thereof.

15. A biometric electronic card system comprising:
a biometric electronic card comprising:
an electronic transactions unit to enable secure financial transactions;
a communications network unit;
a card data encoding storage;
an input/output unit to interact with the biometric electronic card and to verify biometrics of a user;
a power source; and
a location positioning unit,
where the electronic transactions unit, the communications network unit, the card data encoding storage, the input/output unit, the power source and the location positioning unit are all integrated with the biometric electronic card; and
a biometric electronic card case (BECC) comprising:
a BECC input/output unit to interact with the BECC and the biometric electronic card;
a securing mechanism configured to lock and unlock the BECC;
a protective cover surrounding the BECC;
an integrated biometric electronic card case circuit for electronic communication between the BECC and a biometric electronic card;
a BECC power source;
a BECC communications unit;
a processing unit; and
a BECC location positioning unit,
where the BECC input/output unit, the securing mechanism and the protective cover are all integrated with the BECC, and the integrated biometric electronic card case circuit, the BECC power source, the BECC communication unit and the BECC location positioning unit are integrated together.

16. The biometric electronic card system of claim 15, where the BECC further comprises a case enclosure configured to house the biometric electronic card within the BECC and further configured to allow the biometric electronic card to extend from and retract into the BECC.

17. The biometric electronic card system of claim 15, where the electronic transactions unit comprises an EMV chip.

18. The biometric electronic card system of claim 15, the card data encoding storage comprises a magnetic strip.

19. The biometric electronic card system of claim 15, where the processing unit comprises at least one of the following: an Application-Specific Integrated Circuit (ASIC) processor, a Complex Instruction Set Computing (CISC) processor, a central processing unit (CPU), an Explicitly Parallel Instruction Computing (EPIC) processor, a Very Long Instruction Word (VLIW) processor or a combination thereof.

20. The biometric electronic card system of claim 15, where the input/output unit and the BECC input/output unit each comprises at least one of the following: a touchscreen, an OLED display, a TTY interface, a button interface, a joystick, a track ball or a combination thereof.
